(19) United States
(12) Patent Application Publication
(10) Pub. No.: US 2013/0015142 A1
(43) Pub. Date: Jan. 17, 2013

(54) Method and System for Removal of Volatile Contaminants From Water Supplies

(71) Applicants: Ethan Brooke, Biddeford, ME (US); Michael Robin Collins, Lee, NH (US)

(72) Inventors: Ethan Brooke, Biddeford, ME (US); Michael Robin Collins, Lee, NH (US)

(21) Appl. No.: 13/493,117

(22) Filed: Jun. 11, 2012

Related U.S. Application Data
(63) Continuation-in-part of application No. 13/135,666, filed on Jul. 12, 2011.

(51) Int. Cl. C02F 1/58; C02F 1/20

(52) U.S. Cl. 210/718

(57) ABSTRACT

A method of and system for treating water to reduce the level of trihalomethanes or other volatile contaminants such as radon includes the water to be treated (WTBT) being sprayed through a nozzle to aerate the WTBT to increase the air/water interface therein reducing the level of trihalomethanes in the water. In one embodiment, the pressure of the WTBT in the nozzle is adjusted and the nozzle is selected to have a nozzle orifice such that the droplet size of the water to be treated from the nozzle is less than 2000 microns SMD. In addition, the nozzle is spaced from a holding tank for receiving and collecting the sprayed water such that the surface of the treated water is specified at a particular distance based on desired treatment goals.

### CROSS-REFERENCE TO RELATED APPLICATIONS

The present application is a continuation-in-part of U.S. patent application Ser. No. 13/135,666, tiled Jul. 12, 2011, which is incorporated herein by reference.

### TECHNICAL FIELD OF THE INVENTION

The present invention is a method and system for removal of volatile contaminants from water. More specifically, it is a method and system for using spray aeration for removing trihalomethanes and radon from a water supply.

### BACKGROUND OF THE INVENTION

Volatile Organic Compounds (VOCs) are organic chemicals that have a high vapor pressure, or volatility, at ordinary, room-temperature conditions. Their volatility results from a low boiling point, which causes large numbers of molecules to evaporate or sublimate from the liquid or solid form of the compound and enter the surrounding air or water. VOCs are numerous, varied, and ubiquitous. They include both man-made and naturally occurring chemical compounds. VOCs can be present in ground water and be of environmental concern, or VOCs can be present in drinking water and be a public health issue. For example, one group of VOCs is Trihalomethanes (THMs), which are disinfection byproducts (DBPs) found in drinking water. The present invention applies to the removal of VOCs from water, in general, but for simplicity the present invention will be discussed in reference to THMs and radon in drinking water.

Trihalomethanes (THMs) are formed as a by-product when chlorine or bromine is used to disinfect water for drinking. Trihalomethanes are chemical compounds in which halogens replace three of the four hydrogen atoms of methane (CH₄). Halogen is an element from the group that includes fluorine (F), chlorine (Cl), bromine (Br), iodine (I), and astatine (At). Some of the common trihalomethanes .found in water are Choloform (tricholoromethane CHCl₃), Dibromochloromethane (CHBr₂Cl⁻), Bromodichloromethane (CHBrCl₂), and Bromoform (tribromomethane CHBr₃).

There have been some studies such as a California study that suggest a link between miscarriages and disinfection by-products (DBP) of THM in drinking water. The U.S. Environmental Protection Agency (EPA) in recent years has increased the standard related to THM therein reducing the amount of THM in parts per billion (ppb).

The EPA describes radon as an odorless, tasteless and invisible gas produced by the decay of naturally occurring uranium in soil and water. Radon is a form of ionizing radiation and a proven carcinogen. Luna cancer is the only known effect on human health from exposure to radon in air. According to a report on radon released in 1998 by the National Academy of Sciences there about 168 cancer deaths per year: 89% from lung cancer caused by breathing radon released to indoor air from water and 11% from stomach cancer caused by consuming water containing radon. Drinking water that comes from underground sources, as opposed to surface water, is a greater concern since the dissolved radon gas does not have an opportunity to escape into the outside air before it arrives at the tap.

Water systems, such as public water systems, need to balance several, factors in the treatment of water. Some water systems, such as small public water systems, may obtain water from neighboring systems resulting in the water being in the distribution system for longer time periods. This longer time period may result in more disinfection by-products (DSP) such as THMs.

In contrast to conventional systems, the system and method of the instant invention reduces the level of trihalomethanes at minimum cost including both operation and maintenance costs, works well in both large scale and small scale systems, and can take an existing system and modify without requiring major infrastructure expansion.

### SUMMARY OF THE INVENTION

According to the invention, a method of treating water to reduce the level of trihalomethanes or other volatile contaminants includes spraying the water through a nozzle to aerate the water to be treated to increase the air/water interface therein reducing the level of trihalomethanes in the water.

One aspect of the present invention is a method of treating water to reduce the level of volatile contaminants comprising: spraying water into a tank constructed to contain water, wherein the water is sprayed through a nozzle to aerate the water to be treated thereby increasing the air/water interface and reducing the level of volatile contaminants in the water.

One embodiment of the method of treating water to reduce the level of volatile contaminants is wherein the volatile contaminant is radon.

One embodiment of the method of treating water to reduce the level of volatile contaminants is wherein the volatile contaminant is a trihalomethane.

One embodiment of the method of treating water to reduce the level of volatile contaminants further comprises the step of positioning the nozzle above the surface of the water contained in the tank to create a distance over which the air/water interface occurs thereby further increasing the air/water interface and reducing the level of volatile contaminants in the water.

One embodiment of the method of treating water to reduce the level of volatile contaminants is wherein the distance between the nozzle and the surface of the water in the tank is greater than about four meters.

One embodiment of the method of treating water to reduce the level of volatile contaminants is wherein the nozzle has an orifice of about ⅛ inch to about 2 inches.

One embodiment of the method of treating water to reduce the level of volatile contaminants further comprises the step of adjusting the pressure of the water to be treated thereby creating a droplet size of the water exiting the nozzle that is less than 5000 microns SMD.

One embodiment of the method of treating water to reduce the level of volatile contaminants is wherein the droplet size of the water exiting the nozzle is less than 2000 microns SMD.

One embodiment of the method of treating water to reduce the level of volatile contaminants is wherein the droplet size of the water exiting the nozzle is less than 1000 microns SMD.

One embodiment of the method of treating water to reduce the level of volatile contaminants is wherein the droplet size of the water exiting the nozzle is less than 400 microns SMD.

One embodiment Of the method of treating water to reduce the level of volatile contaminants is wherein the droplet size of the water exiting the nozzle is less than 150 microns SMD.

Another aspect of the present invention is a method of treating water to reduce the level of volatile contaminants in water, comprising: pumping the water to be treated in a pipe from a reservoir to a nozzle located in a tank which is constructed to contain water; adjusting the pressure of the water to be treated thereby creating a droplet size of the water exiting the nozzle that is less than 150 microns SMD; and positioning the nozzle at a distance greater than about four meters from the surface of the water in the tank, thereby increasing the air/water interface and reducing the level of volatile contaminants in the water.

Another aspect of the present invention is a drinking water treatment system for reducing the level of volatile contaminants in water, comprising a reservoir for containing water to be treated; a nozzle for spraying the water to be treated; a pipe for carrying the water to be treated from the reservoir to the nozzle; a tank for receiving the treated water; and a pump for pumping the water from the reservoir through the nozzle, wherein the nozzle that is located in the tank has an orifice which produces a droplet size of the water exiting the nozzle that is less than 2000 microns SMD, thereby increasing the air/water interface and reducing the level of volatile contaminants in the water.

One embodiment of the drinking water treatment system for reducing the level of volatile contaminants in water is wherein the droplet size of the water exiting the nozzle that is less than 1000 microns SMD.

One embodiment of the drinking water treatment system for reducing the level of volatile contaminants in water is wherein the droplet size of the water exiting the nozzle that is less than 400 microns SMD

One embodiment of the drinking water treatment system for reducing the level of volatile contaminants in water is wherein the nozzle is at a distance greater than about four meters from the surface of the water in the tank.

One embodiment of the drinking water treatment system for reducing the level of volatile contaminants in water is wherein the volatile contaminant is radon.

One embodiment of the drinking water treatment system for reducing the level of volatile contaminants in water is wherein the volatile contaminant is a trihalomethane.

One embodiment of the drinking water treatment system for reducing the level of volatile contaminants in water is wherein the nozzle has an orifice of about ⅛ inch to about 2 inches.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A and FIG. 1B are schematics systems for removing trihalomethanes (THM) according to the invention.

FIG. 2A and FIG. 2B are graphs showing the removal of various species of THM as a function of the air to water ratio at 20° C. and 1° C. respectively.

FIG. 3 is a graph of actual predicted percent removals of THM v. removal of THMs at 20° C.

FIG. 4A is a schematic of a spray cone area.

FIG. 4B is a schematic of the cone showing the average droplet travel distance.

FIG. 4C is a schematic of the volumetric ratio of droplet path.

FIG. 5A is a graph of percent removal of chloroform (CF) versus air-to-water ratio for spray aeration.

FIG. 5B is a graph of percent removal of dichlorobromomethane (DCBM) versus air-to-water ratio for spray aeration.

FIG. 5C is a graph of percent removal of chlorodibromomethane (CDBM) versus air-to-water ratio for spray aeration.

FIG. 5D is a graph of percent removal of bromoform (BF) versus air-to-water ratio for spray aeration.

### DETAILED DESCRIPTION OF THE INVENTION

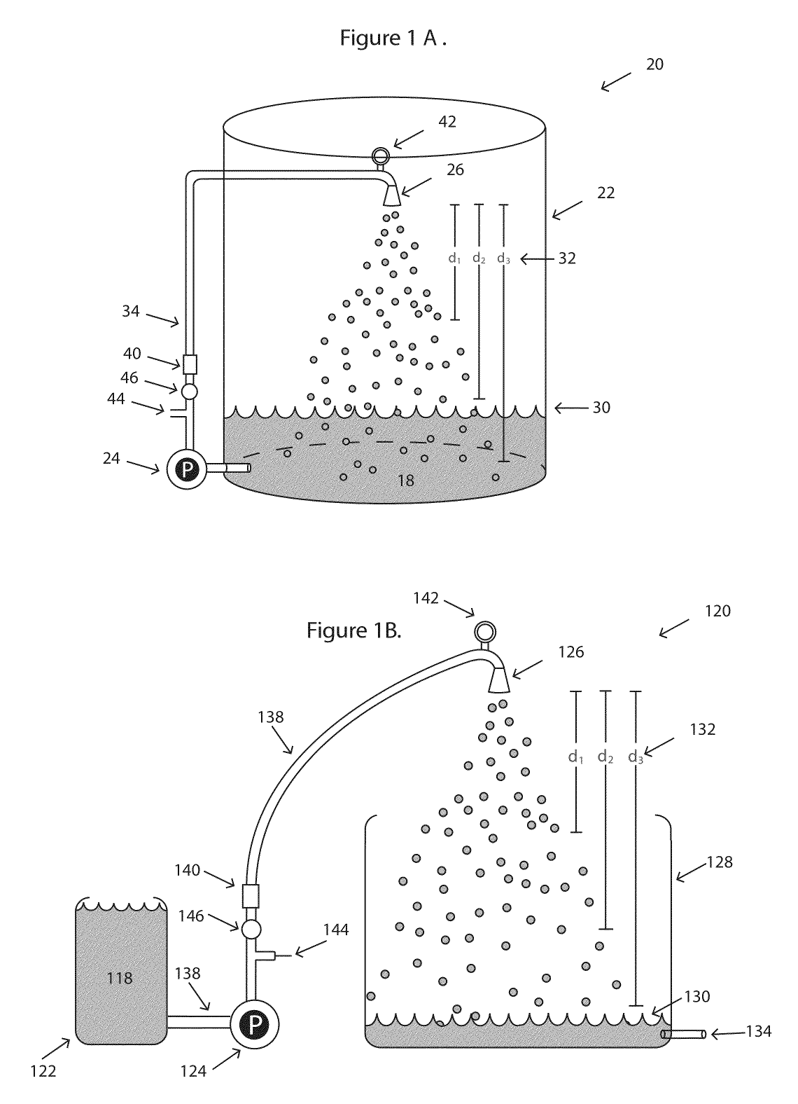

The present invention is a system 20 and a method for treating water to reduce levels of trihalomethanes. Referring to FIG. 1A, a schematic of a system 20 for removing trihalomethanes (THM) according to the invention is shown. The system 20 draws water from a water storage tank or chlorine contact basin 22. The water storage tank or chlorine contact basin 22 contains stored drinking water 18 that has been treated by disinfectants such as chlorine or bromine. The drinking water, the water to be treated (WTBT), 18 is drawn from the water storage tank or chlorine contact basin 22 by a pump 24 to an aeration spray head or nozzle 26. The aerator spray head 26 is located above the surface of the stored drinking water 30 and is shown having a distance 32 below the aerator spray head 26. The water storage tank or chlorine contact basin 22 has spray aeration pipe 34 for recirculating water through the spray head or nozzle 26. The spray aeration pipe 34 links the water storage tank or chlorine contact basin 22 to the aerator spray head or nozzle 26. In addition to passing through the pump 24, the spray aeration pipe 34 has various monitoring systems including a flow monitor 40 and a pressure monitor or gauge 42 and a sample taking location 44. In addition, the system 20 has a flow control valve 46 that influences the drinking water 18 as it flows through the pipe 34.

In a prototype, various operating conditions and design variables were tested. Table I and Table II show the variables.

TABLE I
Initial Spray Aeration Design and Operating Variables

| | Level 1 | Level 2 | Level 3 | Level 4 |
|---|---|---|---|---|
| Operating Conditions | | | | |
| TTHM Concentration (ug/L) | 50 | 125 | 200 | 400 |
| Design Variables | | | | |
| Nozzle Type | 1 | 2 | | |
| Operating Pressure (PSI) | 2 | 20 | | |

TABLE II
Spray Aeration Pilot Scale Optimization Trials Operating and Design
Variables

| | Level 1 | Level 2 | Level 3 | Level 4 |
|---|---|---|---|---|
| Operating Conditions | | | | |
| Water Temperature (c) | 1 | 22 | 36 | |
| Design Variables | | | | |
| Droplet Travel Distance (m) | 0.74 | 2.13 | 4.27 | |
| Droplet SMD (u) | 140 | 350 | 690 | 1100 |

Referring to FIG. 1B, a prototype, pilot scale experimental apparatus of the system 120 consisted of a 55 gallon drum representing the reservoir 122. The reservoir 122 contained water to be treated consisting of reverse osmosis filtered (RO) water dosed with a stock solution of chloroform, bromoform, dibromochloromethane and bromodichloromethane 118. The water to be treated (WTBT) was tested for chlorine using a hatch chlorine pocket spectrometer test kit and was found to have 0.00 mg/L of free chlorine. The water to be treated (WTBT) 118 was drawn from the reservoir 122 by a pump 124 to an aeration spray head or nozzle 126. The aerator spray head 126 was located above a holding tank 128 having THM or other volatile contaminant-reduced drinking water, the treated water, 130. The surface of treated drinking water 130 is shown having a distance 132 below the aerator spray head 126. The holding tank 128 had an outlet pipe 134 for removing water from the holding tank 128. The water flowed from the reservoir 122 to the aerator spray head or nozzle 126 through a pipe 138. In addition to passing through the pump 124, the pipe 138 had various monitoring systems including a flow monitor 140 and a pressure monitor or gauge 142 and a sample taking location 144. In addition, the system 120 had a flow control valve 146 that influenced the drinking water 118 as it flowed through the pipe 138.

All THM concentration analysis was conducted using the modified version of EPA method 551.1. The electron capture gas chromatograph used in analysis was an Agilent Technologies 6890N GC-ECD, fitted with an Agilent 7683 Series auto sampler and auto injector. Included with each batch of samples was a lab-created spiked sample for calibration. The squared correlation coefficient (R2) for spiked samples (provided by the lab) was greater than 0.99 for all four species of THMs, indicating satisfactory analytical accuracy.

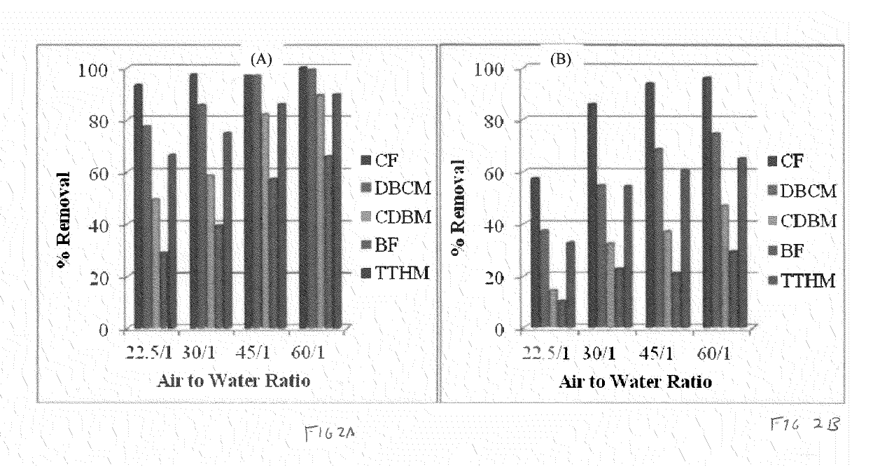

Referring to FIGS. 2A and 2B, the percent removals of each THM species versus air to water ratio at one degree Celsius and twenty degrees Celsius is shown. Air to water ratio had a significant effect on THM concentration, with THM removal rates increasing proportionally to an increasing air to water ratio as seen in FIGS. 2A and 2B. The influence of Henry's constant for the particular THM species on achieved removals was also significant. Chloroform having the highest Henry's constant was the species most amenable to removal by aeration followed in order of descending Henry's constants by chlorodibromommethane, bromodichloromethane, and bromoform.

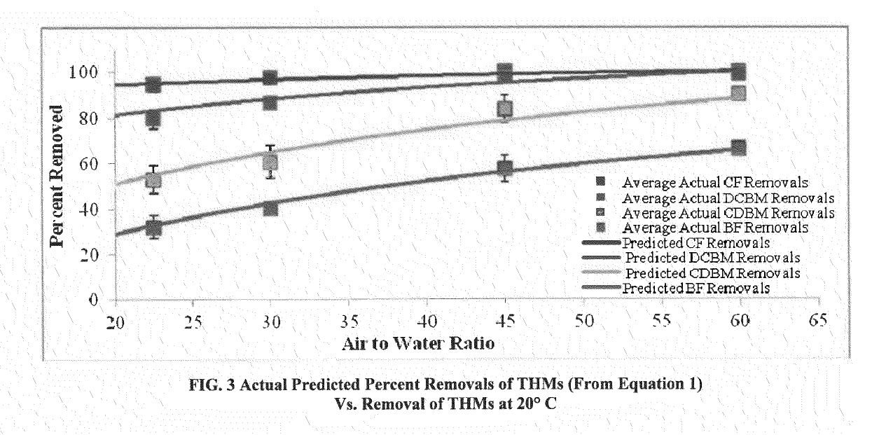

In order to design a spray aeration system based on operating conditions and treatment objectives, several diffused aeration models based on a minimum air to water ratio were evaluated. Diffused aeration is where bubbles of air, pass through liquid versus spray aeration where droplets of liquid pass through air. The one that best matched experimental results is shown in Equation 1. Predicted and empirical results are shown in FIG. 3. It should be noted that this equation is specific to hatch mode aeration.

$$ln {C}_{e} = - ( \frac{{H}_{cc} V}{{V}_{w}} \cdot t ) + ln {C}_{o} \\ {C}_{o} = Initial Concentration \\ {C}_{e} = Effluent Concentration \\ {H}_{cc} = Henrys Constant \\ V = Air Flow Rate \\ {V}_{w} = Water Volume \\ t = Time \qquad ( 1 )$$

While the first round of testing was done with diffused aeration, diffused and spray aeration rely on the same mechanisms for mass transport; a concentration gradient drives the THMs through an interfacial surface area, moving the THMs from a liquid phase to a gas phase. The key difference between diffused and spray aeration is that the bubbles created in diffused aeration have a finite volume and can reach saturation rapidly. This means that THM removal may only occur for the first few feet of bubble contact. Because bubbles have a small volume, the gas concentration of THMs inside the bubbles increases over time, lessening the concentration gradient that provides the driving force for mass transfer. Spray aeration offers a larger, air volume, greatly lessening the effect of a decreasing concentration gradient, and therefore offering the potential for a more efficient THM removal using an aeration strategy. Like a diffused aeration apparatus, a spray aerator could be placed in a water tower or a clear well chlorine contact chamber.

Finally, spray aeration requires water pressure to make an air/water interface, while diffused aeration requires air pressure. Because water pressure is already required for filling a water tank, the instant invention recognizes that some systems 20 may require nothing more than a redesign of the water tank influent piping and the addition of a spray nozzle 26 in order to realize significant THM reductions. Other systems will require an additional pump or set of pumps to re-circulate the water in the tank through the one or more spray nozzles.

The spray aeration pilot scale experiments focused on an assessment of operating and design variables affecting THM removal rates with an emphasis on gathering enough information to accurately create a model which could be utilized to design and build an actual spray aeration apparatus in the field. With that goal in mind, all design and operating variables were chosen to either reflect likely worst case operating conditions, or design variables identified as likely to influence THM removals. Design and operating variables for the spray aeration pilot scale optimization trails are summarized in Table III.

TABLE III
Spray Aeration Pilot Scale Optimization Trials Operating and Design
Variables

| | Level 1 | Level 2 | Level 3 | Level 4 |
|---|---|---|---|---|
| Operating Conditions | | | | |
| Water Temperature (c) | 1 | 22 | 36 | |
| Design Variables | | | | |
| Droplet Travel Distance (m) | 0.74 | 2.13 | 4.27 | |
| Droplet SMD (u) | 140 | 350 | 690 | 1100 |

In the prototype, for the spray aeration pilot scale optimization experimental trials, spray nozzles from nozzle manufacturer BETE Fog Nozzle, Inc. (Greenfield, Mass.) were selected. These nozzles 26 were chosen because the nozzles 26 are able to produce a wide variety of droplet sizes (based on nozzle type and operating pressure) but have only one nozzle orifice. This was considered a design advantage because the large opening should help to prevent nozzle clogging. The second design variable selected for this experiment was droplet travel distance; the distance a droplet travels after exiting the nozzle 26 before splashing down onto the water surface. This was considered an important variable because the time it takes the droplet to travel from the nozzle exit to the water surface 50 is the time in which mass transfer can occur. By varying the droplet travel distance while keeping the nozzle exit velocity and droplet SMD constant, an assessment of the influence of air to water contact time was evaluated. The experimental apparatus shown in FIG. 1 was used. The average initial THM concentration before aeration was 112 ug/L. The influence of the spray aeration pilot scale experimental factors is summarized in Table IV.

TABLE IV
Influence of Spray Aeration Pilot Scale Experimental Factors on TTHM
Removal

| Parameter | CF | DCBM | CDBM | BF | TTHM |
|---|---|---|---|---|---|
| Droplet Travel Distance | 34.38758 | 36.06 | 33.55 | 29.89 | 33.11 |
| Temperature | 18.73616 | 16.64 | 17.64 | 18.25 | 18.71 |
| Sauter Mean Diameter of | 12.57438 | 12.80 | 15.29 | 18.56 | 14.24 |
| Droplet | | | | | |
| Droplet Travel | 7.578491 | 7.57 | 6.03 | 6.46 | 6.89 |
| Distance * | | | | | |
| Temperature | | | | | |
| Error | 26.72339 | 26.93 | 27.49 | 26.84 | 27.05 |

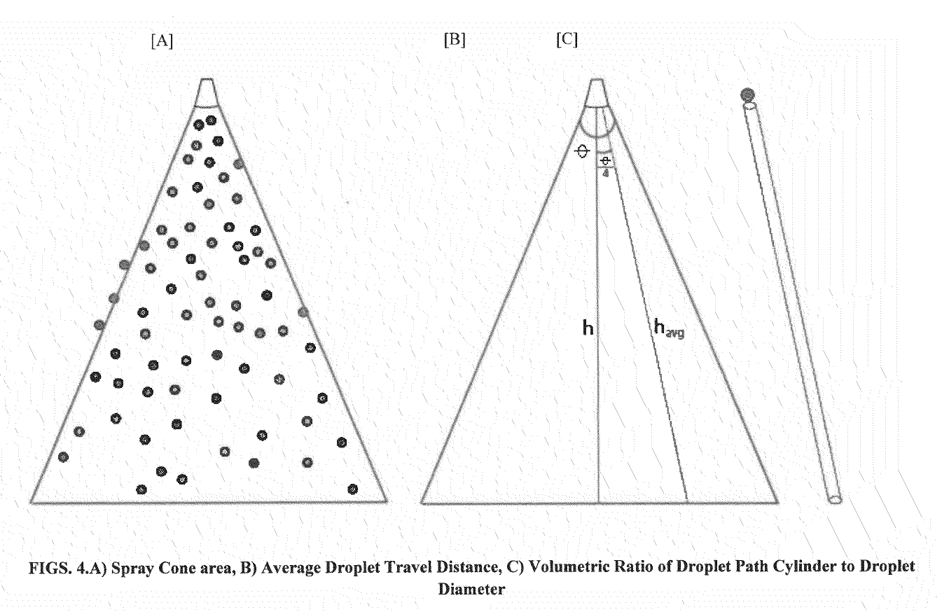

FIG. 4A shows a schematic of a spray cone area. As a water droplet falls, the space it moves through has a volume and can be visualized as a long cylinder with a height (h) equal to the average distance the droplet travels from nozzle exit to splash down and a diameter (d) equal to the average droplet diameter as seen in FIG. 4B. The average droplet travel distance has been assumed to be equal to a droplet travel path half way between the maximum droplet travel distance at the exterior of the spray cone and the smallest droplet travel distance, at the center of the spray cone. This ratio of volumetric interfacial ratio, shown in Equation 2 is analogous to an air to water ratio used in counter current packed towers or diffused aeration.

$$Ratio of Volumetric Interfacial Areas = \frac{\frac{π {d}^{2} {h}_{avg}}{4}}{\frac{π {d}^{3}}{6}} = \frac{1.5 {h}_{avg}}{d} \\ d = Droplet Sauter Mean Diameter \\ {h}_{avg} = Average Droplet Travel Distance \qquad ( 2 )$$

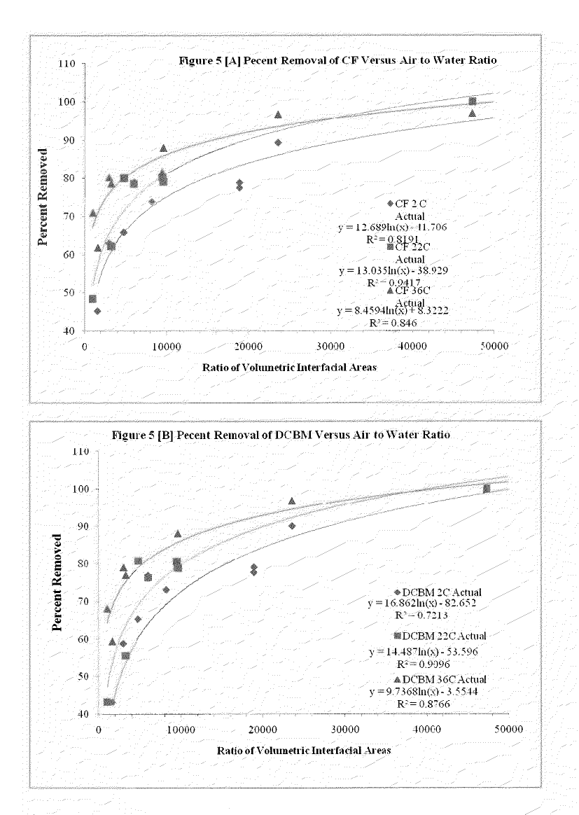

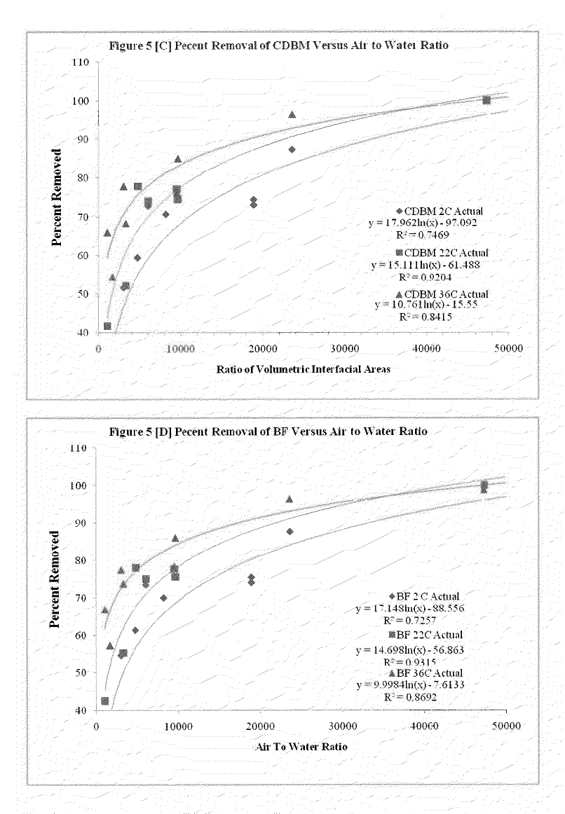

By comparing the volumetric ratio to the percent removals achieved, a set of design graphs for each species of THM, FIGS. 5A-5D, was created. These design graphs are useful to the design engineer because operating variables such as THM speciation and required percent reduction, droplet travel distance (based on storage tank dimensions and pumping regime), and operating temperature range are usually known variables. Based on that information, the required droplet diameter for a spray aeration apparatus can be calculated using the information in FIGS. 5A-5D. The graphs were plots of experimental data, and generating lines that are “best fit” to the data points. The R² valves describe how well the line fits the data.

in one embodiment of the present invention, the size of the nozzle orifice, the inner diameter, can vary to increase the air/water interface. In one embodiment the size of the nozzle orifice is from about 1/16 inch to about 3 inches. In one embodiment the size of the nozzle orifice is from about ⅛ inch to about 2 inches. In one embodiment the size of the nozzle orifice is from about 3/16 inch to about 1.5 inches. In one embodiment the size of the nozzle orifice is from about ¼ inch to about 1 inch. In one embodiment the size of the nozzle orifice is about 1/16 inch, about ⅛ inch, about 3/16 inch, about ¼ inch, about 5/16 inch, about ⅜ inch, about 7/16 inch, or about ½ inch. In one embodiment the size of the nozzle orifice is about 9/16 inch, about ⅝ inch, about 11/16 inch, about ¾ inch, about 13/16 inch, about ⅞ inch, about 15/16 inch, or about 1 inch. In one embodiment the size of the nozzle orifice is about 1 1/16 inches, about 1⅛ inches, about 1 3/16 inches, about 1¼ inches, about 1 5/16 inches, about 1⅜ inches, about 1 7/16 inches, or about 1½ inches. In one embodiment the size of the nozzle orifice is about 1 9/16 inches, about 1⅝ inches, about 1 11/16 inches, about 1¾ inches, about 1 13/16 inches, about 1⅞ inches, about 1 15/16 inches, or about 2 inches. In one embodiment the size of the nozzle orifice is about 2 1/16 inches, about 2⅛ inches, about 2 3/16 inches, about 2¼ inches, about 2 5/16 inches, about 23/8 inches, about 2 7/16 inches, or about 2½ inches. In one embodiment the size of the nozzle orifice is about 2 9/16 inches, about 2⅝ inches, about 2 11/16 inches, about 2¾ inches, about 2 13/16 inches, about 2⅞ inches, about 2 15/16 inches, or about 3 inches.

In one embodiment of the present invention, the droplet size of the water exiting the nozzle can vary to increase the air/water interface. In one embodiment, the droplet size of the water exiting the nozzle is less than about 5000 microns Sauter mean diameter (SMD). In one embodiment, the droplet size of the water exiting the nozzle is less than about 4000 microns SMD. In one embodiment, the droplet size of the water exiting the nozzle is less than about 3000 microns SMD. In one embodiment, the droplet size of the water exiting the nozzle is less than about 2000 microns SMD. In one embodiment, the droplet size of the water exiting the nozzle is less than about 1000 microns SMD.

In one embodiment, the droplet size of the water exiting the nozzle is less than about 900 microns SMD. In one embodiment, the droplet size of the water exiting the nozzle is less than about 800 microns SMD. In one embodiment, the droplet size of the water exiting the nozzle is less than about 700 microns SMD. In one embodiment, the droplet size of the water exiting the nozzle is less than about 600 microns SMD. In one embodiment, the droplet size of the water exiting the nozzle is less than about 500 microns SMD.

In one embodiment, the droplet size of the water exiting the nozzle is less than about 450 microns SMD. In one embodiment, the droplet size of the water exiting the nozzle is less than about 400 microns SMD. In one embodiment, the droplet size of the water exiting the nozzle is less than about 350 microns SMD. In one embodiment, the droplet size of the water exiting the nozzle is less than about 300 microns SMD. In one embodiment, the droplet size of the water exiting the nozzle is less than about 250 microns SMD. In one embodiment, the droplet size of the water exiting the nozzle is less than about 200 microns SMD. In one embodiment, the droplet size of the water exiting the nozzle is less than about 150 microns SMD. In one embodiment, the droplet size of the water exiting the nozzle is less than about 100 microns SMD.

In one embodiment of the present invention, the nozzle is positioned above the surface of the water contained in the tank to create a distance over which the air/water interface occurs. This distance can vary to increase the air/water interface. In one embodiment, the distance between the nozzle and the surface of the water in the tank is greater than about one meter. In one embodiment, the distance between the nozzle and the surface of the water in the tank is greater than about two meters. In one embodiment, the distance between the nozzle and the surface of the water in the tank is greater than about three meters. In one embodiment, the distance between the nozzle and the surface of the water in the tank is greater than about four meters. In one embodiment, the distance between the nozzle and the surface of the water in the tank is greater than about five meters. In one embodiment, the distance between the nozzle and the surface of the water in the tank is greater than about six meters.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art arc considered to be within the scope of the present invention.

What is claimed is:

1. A method of treating water to reduce the level of volatile contaminants, the method comprising:
spraying water into a tank constructed to contain water, wherein the water is sprayed through a nozzle to aerate the water to be treated thereby increasing the air/water interface and reducing the level of volatile contaminants in the water.

2. The method of treating water to reduce the level of volatile contaminants of claim 1, wherein the volatile contaminant is radon.

3. The method of treating water to reduce the level of volatile contaminants of claim 1, wherein the volatile contaminant is a trihalomethane.

4. The method of treating water to reduce the level of volatile contaminants of claim 1, further comprising the step of positioning the nozzle above the surface of the water contained in the tank to create a distance over which the air/water interface occurs thereby further increasing the air/water interface and reducing the level of volatile contaminants in the water.

5. The method of treating water to reduce the level of volatile contaminants of claim 4, wherein the distance between the nozzle and the surface of the water in the tank is greater than about four meters.

6. The method of treating water to reduce the level of volatile contaminants of claim 1, wherein the nozzle has an orifice of about ⅛ inch to about 2 inches.

7. The method of treating water to reduce the level of volatile contaminants of claim 1, further comprising the step of adjusting the pressure of the water to be treated thereby creating a droplet size of the water exiting the nozzle that is less than 5000 microns SMD.

8. The method of treating water to reduce the level of volatile contaminants of claim 1, wherein the droplet size of the water exiting the nozzle is less than 2000 microns SMD.

9. The method of treating water to reduce the level of volatile contaminants of claim 1, wherein the droplet size of the water exiting the nozzle is less than 1000 microns SMD.

10. The method of treating water to reduce the level of volatile contaminants of claim 1, wherein the droplet size of the water exiting the nozzle is less than 400 microns SMD.

11. The method of treating water to reduce the level of volatile contaminants of claim 1, wherein the droplet size of the water exiting the nozzle is less than 150 microns SMD.

12. A method of treating water to reduce the level of volatile contaminants in water, comprising:
pumping the water to be treated in a pipe from a reservoir to a nozzle located in a tank which is constructed to contain water;
adjusting the pressure of the water to be treated thereby creating a droplet size of the water exiting the nozzle that is less than 150 microns SMD; and
positioning the nozzle at a distance greater than about four meters from the surface of the water in the tank, thereby increasing the air/water interface and reducing the level of volatile contaminants in the water.

13. A drinking water treatment system for reducing the level of volatile contaminants in water, comprising:
a reservoir for containing water to be treated;
a nozzle for spraying the water to be treated;
a pipe for carrying the water to be treated from the reservoir to the nozzle;
a tank for receiving the treated water; and
a pump for pumping the water from the reservoir through the nozzle, wherein the nozzle that is located in the tank has an orifice which produces a droplet size of the water exiting the nozzle that is less than 2000 microns SMD, thereby increasing the air/water interface and reducing the level of volatile contaminants in the water.

14. The drinking water treatment system for reducing the level of volatile contaminants in water of claim 13, wherein the droplet size of the water exiting the nozzle that is less than 1000 microns SMD.

15. The drinking water treatment system for reducing the level of volatile contaminants in water of claim 13, wherein the droplet size of the water exiting the nozzle that is less than 400 microns SMD

16. The drinking water treatment system for reducing the level of volatile contaminants in water of claim 13, wherein the nozzle is at a distance greater than about four meters from the surface of the water in the tank.

17. The drinking water treatment system for reducing the level of volatile contaminants in water of claim 13, wherein the volatile contaminant is radon.

18. The drinking water treatment system for reducing the level of volatile contaminants in water of claim 13, wherein the volatile contaminant is a trihalomethane.

19. The drinking water treatment system for reducing the level of volatile contaminants in water of claim 13, wherein the nozzle has an orifice of about ⅛ inch to about 2 inches.
